(19) United States
(12) Patent Application Publication
(10) Pub. No.: US 2010/0314790 A1
(43) Pub. Date: Dec. 16, 2010

(54) Highly Oriented Graphite Product

(76) Inventors: Peter G. Stansberry, North Olmsted, OH (US); Richard L. Shao, North Royalton, OH (US); Douglas J. Miller, Broadview Heights, OH (US)

Correspondence Address: GrafTech International Holdings, Inc., 12900 Snow Road, Parma, OH, 44130, US

(21) Appl. No.: 12/483,796

(22) Filed: Jun. 12, 2009

(51) Int. Cl. C01B 31/00

(52) U.S. Cl. 264/29.1

(57) ABSTRACT

A graphite article having enhanced directional thermal conductivity is provided. The mesophase portions of a mesophase pitch are aligned with each other to create an oriented mesophase pitch which may be stabilized. The article may subject to further carbonization and graphitization as needed.

### BACKGROUND OF THE INVENTION

1. Field of the Invention

The disclosure relates to the production of high strength graphite having a direction of enhanced conductivity, especially thermal conductivity. In one embodiment, the graphite is formed using mesophase powder which is stabilized and aligned, and can be graphitized to provide a graphite having a direction of enhanced thermal and electrical conductivity. Methods for the production of such graphite are also disclosed.

2. Description of the Prior Art

Graphite articles have an enormous amount of potential for a variety of applications, some of the most significant of which include uses in electronic thermal management, lithium ion batteries, electrochemical fuel cells, and other applications where a non-reactive material like graphite is needed. However, conventionally-produced graphite does not have sufficient thermal conductivity for many applications, especially electronic thermal management.

Generally, graphite articles may be fabricated by combining a carbon material and a binder matrix, especially a pitch binder, into a stock blend. Other additives that may be incorporated into the small particle size filler include iron oxides to inhibit puffing (caused by release of sulfur from its bond with carbon inside the coke particles), coke powder and oils or other lubricants to facilitate extrusion of the blend.

The stock blend is heated to the softening temperature of the pitch and is form pressed to create a “green” stock body, using a continuously operating extruding press or by die extrusion or by molding in a forming mold to form a “green body.”

The green stock body is heated in a furnace to carbonize the pitch so as to give the body permanency of form and higher mechanical strength. Depending upon the size of the graphite body and upon the specific manufacturer's process, this “baking” step requires the green body to be heat treated at a temperature of between about 700° C. and about 1100° C. To avoid oxidation, the green stock body is baked in the relative absence of air. Typically, the temperature of the body is raised at a constant rate to the final baking temperature. In some embodiments, the green stock body is maintained at the final baking temperature for between 1 week and 2 weeks, depending upon the size of the body.

After cooling and cleaning, the baked body may be impregnated one or more times with coal tar or petroleum pitch, or other types of pitches known in the industry, to deposit additional pitch coke in any open pores of the body. Each impregnation is then followed by an additional baking step, including cooling and cleaning. The time and temperature for each re-baking step may vary, depending upon the particular manufacturer's process. Additives may be incorporated into the pitch to improve specific properties of the graphite body. Each such densification step (i.e. each additional impregnation and re-baking cycle) generally increases the density of the stock material and provides for a higher mechanical strength. Typically, forming each body includes at least one densification step. Many such articles require several separate densification steps before the desired density is achieved.

After densification, the body, referred to at this stage as carbonized body, is then graphitized. Graphitization is by heat treatment at a final temperature of between about 1500° C. to about 3400° C. for a time sufficient to cause the carbon atoms in the calcined coke and pitch coke binder to transform from a poorly ordered state into the crystalline structure of graphite. At these high temperatures, elements other than carbon are volatilized and escape as vapors.

After graphitization is completed, the body can be cut to size and then machined or otherwise formed into its final configuration. Given its nature, graphite permits machining to a high degree of tolerance.

As noted, the binder matrix is advantageously a pitch. Natural and synthetic pitches are complex mixtures of organic compounds which, except for certain rare paraffinic-base pitches derived from certain petroleums, such as Pennsylvania crude, are made up essentially of fused ring aromatic hydrocarbons and are, therefore, said to have an aromatic base. Since the molecules which make up these organic compounds are comparatively small (average molecular weight not more than a few hundred) and interact only weakly with one another, such pitches are isotropic in nature.

On heating these pitches under quiescent conditions at a temperature of about 350° C.-450° C., however, either at constant temperature or with gradually increasing temperature, small liquid spheres begin to appear in the pitch, which gradually increase in size as heating is continued. When examined by electron diffraction and polarized light techniques, these spheres are shown to consist of layers of oriented molecules aligned in the same direction. As these spheres continue to grow in size as heating is continued, they come in contact with one another and gradually coalesce with each other to produce larger masses of aligned layers. As coalescence continues, domains of aligned molecules much larger than those of the original spheres are formed. These domains come together to form a bulk mesophase wherein the transition from one oriented domain to another sometimes occurs smoothly and continuously through gradually curving lamellae and sometimes through more sharply curving lamellae.

The differences in orientation between the domains create a complex array of polarized light extinction contours in the bulk mesophase corresponding to various types of linear discontinuity in molecular alignment. The ultimate size of the oriented domains produced is dependent upon the viscosity, and the rate of increase of the viscosity, of the mesophase from which they are formed, which, in turn are dependent upon the particular pitch and the heating rate. In certain pitches, domains having sizes in excess of two hundred microns up to several hundred microns are produced. In other pitches, the viscosity of the mesophase is such that only limited coalescence and structural rearrangement of layers occur so that the ultimate domain size does not exceed one hundred microns.

The highly oriented, optically anisotropic material produced by treating pitches in this manner has been given the term “mesophase,” and pitches containing such material are known as “mesophase pitches.” Such pitches, when heated above their softening points, are mixtures of two immiscible liquids, one the optically anisotropic, oriented mesophase portion, and the other the isotropic non-mesophase portion. The term “mesophase” is derived from the Greek “mesos” or “intermediate” and indicates the pseudo-crystalline nature of this highly-oriented, optically anisotropic material.

The highly oriented mesophase spheres which begin to appear in a pitch when it is gradually heated are not only optically anisotropic, but also diamagnetically anisotropic, i.e., they have a large diamagnetic susceptibility in a direction normal to the layers of oriented molecules, and a small susceptibility in a direction parallel to these layers. As a result, when pitch containing such spheres is subjected to a magnetic field, the spheres tend to align themselves with their layer planes parallel to the direction of the magnetic field. However, while this orienting effect causes an alignment of the layer planes of the spheres in a direction parallel to that of the magnetic field, the polar or c-axes of the spheres remain free to rotate in a plane perpendicular to the direction of the magnetic field, so that there is no parallel alignment of the polar axes of the spheres.

In accordance with the Singer U.S. Pat. No. 3,991,170, the details of which are incorporated herein by reference, it has been shown that mesophase pitches wherein the layer planes of the mesophase portions of such pitches are substantially aligned in a single parallel direction, and the c-axes of said planes are substantially aligned in a single parallel direction, can be produced by subjecting a mesophase pitch in its molten state to rotational motion relative to a surrounding magnetic field about an axis perpendicular to the direction of that field. The magnetic field subjects the mesophase portions of the pitch to a diamagnetic force which tends to align the layer planes of said mesophase portions in a direction parallel to that of the magnetic field, and when the pitch is simultaneously rotated relative to the field about an axis perpendicular to the field, this diamagnetic force also acts to align the c-axes of said layer planes parallel to the axis of rotation. This unique orientation can be obtained by continuously spinning the pitch in the magnetic field, or rotating the field about the pitch.

The Singer patent also teaches that solid pitch articles can be produced when the planes of the mesophase portions of the pitch are substantially aligned in a single parallel direction, and the c-axes of said planes are substantially aligned in a single parallel direction, thus producing a pitch article which has a preferred plane of increased thermal and electrical conductivity over and beyond that achieved by thermal processes alone.

Further development of the Singer process has been shown in Singer, “Anisotropy of the Thermal Expansion of a Highly-Oriented Mesophase Pitch,” presented at the 19th Biennial Conference on Carbon, at the Pennsylvania State University, Jun. 25-30 (1989), the details of which are incorporated herein by reference.

What is desired, therefore, is a graphite formed using mesophase pitch, having improved thermal conductivity.

### BRIEF DESCRIPTION

Disclosed herein are methods of making a highly oriented graphite product from a mesophase pitch precursor. One method disclosed herein includes the following: (a) molding milled particles of mesophase pitch into a desired shaped article; (b) orienting the article; and (c) stabilizing the article. Another method that may be practiced includes: (a) molding milled particles of mesophase pitch into a desired shaped article; (b) partially stabilizing the article; (c) orienting the article; and (d) stabilizing the oriented article.

A further method disclosed herein includes: (a) partially stabilizing mesophase pitch molding powder; (b) molding the powder into an article; (c) orienting the article; and (d) stabilizing the oriented article.

Any additional method disclosed herein includes: (a) casting mesophase pitch into a template, the template constructed from a sacrificial material in an approximate shape of the negative image of a desired graphite article, thereby forming a work piece; (b) orienting the work piece; (c) stabilizing the work piece; (d) carbonizing at least the stabilized and oriented mesophase pitch of the work piece; and (e) removing the sacrificial material. Another method disclosed herein includes: (a) impregnating a first body with mesophase pitch, thereby forming an impregnated body, the first body including at least one material selected from carbon, graphite, and combinations thereof; (b) orienting the pitch in the impregnated body; and (c) carbonizing the pitch in the impregnated body, thereby forming a densified body.

The above methods may be practiced to produce porous or non-porous carbon and/or graphite bodies. The above methods may also be practiced to produce carbon and/or graphite bodies with desired densities. The above methods may further be practiced to produce carbon and/or graphite bodies with enhanced conductivity in at least the direction of orientation.

In a certain embodiment, the stabilization of the article is preferably affected prior to alignment. In one embodiment the molding powder is sized so as to average no greater than 20 mesh. In a further embodiment, the molding powder may have particles having at least one dimension up to about ⅛″ (5 mesh or less).

Other and further objects features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a block diagram flow chart of the process of the present invention.

FIG. 2 is a schematic representation of a graphite article having a planar direction of enhanced thermal conductivity in the “a-b” plane.

FIG. 3 is a schematic diagram illustrating the orientation of mesophase spheres in a pitch subjected to magnetic field (H).

FIG. 4 is a schematic diagram illustrating the orientation of mesophase spheres in a molten pitch which has been rotated about axis (Z) perpendicular to magnetic field (H).

FIG. 5 is a schematic illustration of an apparatus for rotating a container of molten mesophase pitch in a magnetic field.

FIG. 6 is a schematic plan view of a pitch sample and magnet arrangement similar to FIG. 4, except with the magnets being mounted to rotate relative to the pitch sample.

FIG. 7 is a schematic plan view of an alternative embodiment similar to FIG. 6 wherein the rotating magnetic field is provided by switching between a series of magnetic poles located about the circumference of the pitch sample.

### DETAILED DESCRIPTION

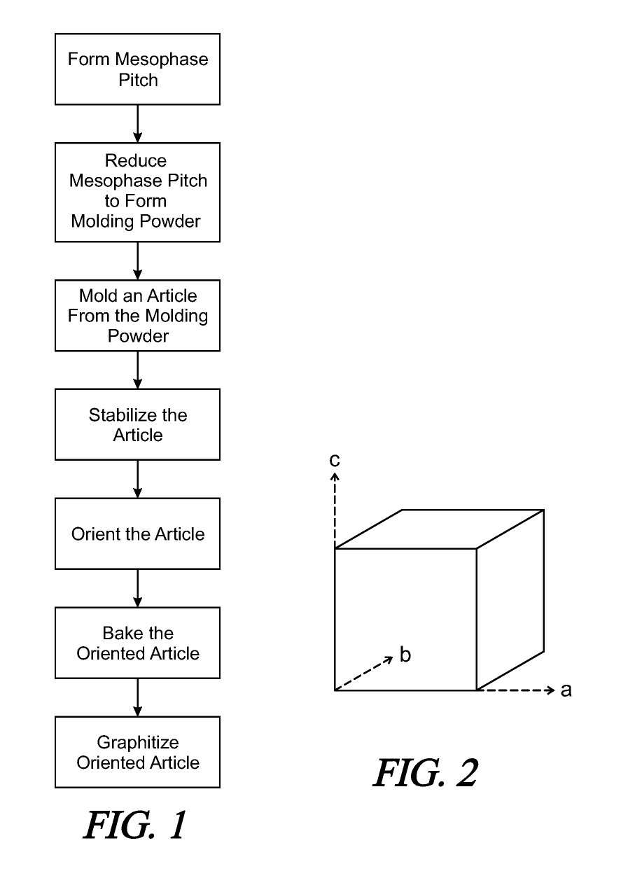

An embodiment disclosed herein is illustrated in FIG. 1 and include the following steps:
(a) providing or forming the mesophase pitch;
(b) reducing the mesophase pitch to thereby form a molding powder;
(c) molding an article from the powder;
(d) stabilizing the article (in an embodiment, the article may be a green body);
(e) orienting the article;
(f) optionally baking the oriented article, thereby forming a carbonized body; and
(g) optionally graphitizing the carbonized body to form a graphite article.
   In one embodiment, stabilization includes treating the article with air and/or an oxidizing agent. In another embodiment, stabilization includes treating the article to cross link the pore walls of the article. In a different embodiment, the powder may be stabilized.

FIG. 2 schematically illustrates a graphite product having a planar direction of enhanced thermal conductivity in the “a” and “b” axes as shown relative to a much lesser thermal conductivity in the direction normal to the planar direction, which is often referred to as the “c” direction or axis. The layer planes of the molecules are oriented generally parallel to the a-b plane.

The thermal conductivity in the planar direction, that is in the a-b plane, of a graphite article constructed in accordance with the present invention can be about 200 W/mK or higher; preferably about 400 W/mK or higher; more preferably about 600 W/mK or higher, and even more preferably about 1200 W/mK or higher. In another embodiment, the thermal conductivity is less than about 2000 W/mK; further it may be less than about 1500 W/mK or higher. By contrast, the thermal conductivity in the “c” direction may be in the range of about 1 to about 50 W/mK.

The graphite product is not limited to any particular density. The product may be a high density product or a low density product. In one embodiment, the density may be controlled by controlling the size of the powder that is molded together. To make a high density product, the molding powder may be sized so as to average no greater than about 20 mesh. In another embodiment, the powder may have distribution of sizes which ranges between up to at least about 8 different diameter sizes. In an additional embodiment, the molding powder to be used in the making of a high density product may be a distribution of sized powders that pack well. In a certain embodiment, the particle size of at least a majority of the powder comprises no more than about 150 microns, preferably substantially all of the powder.

With respect to a low density graphite product, various options are available to form a molded article with a low density (A.K.A. porous structure). In one embodiment, the particles which make up the powder are a narrowly screened sample of particles. An example of an narrowly screed distribution of particles may be a distribution of particles in which a majority of the particles are within no more than five (5) mesh sizes of each other, more preferably substantially all of the particles. In another example such a distribution of particles may be defined in terms of a ratio of the diameter of the largest particle (D₁) to the diameter of the smallest particle (Dₛ). A preferred ratio is D₁/Dₛ of less than a about three (3), more preferably of no more than about two (2). One example of a low density article, may be an article which may be graphitized into graphite body having a density of about 1.7 g/cc or less or a porosity of at least about twenty-five (25%) percent or more. Examples of suitable porosities include at least thirty (30%) percent, at least forty (40%) percent, and at least fifty (50%) percent.

Another technique for creating a low density product is to use particles of shapes that will not pack well together. In one example the particles have substantially similar shapes, preferably substantially the same shape. In another example, the particles have a shape that does not pack well, such as, but not limited to, rice like shapes, shapes having a void, e.g., ring like, shapes with lobes or points, such as a jack shaped particle.

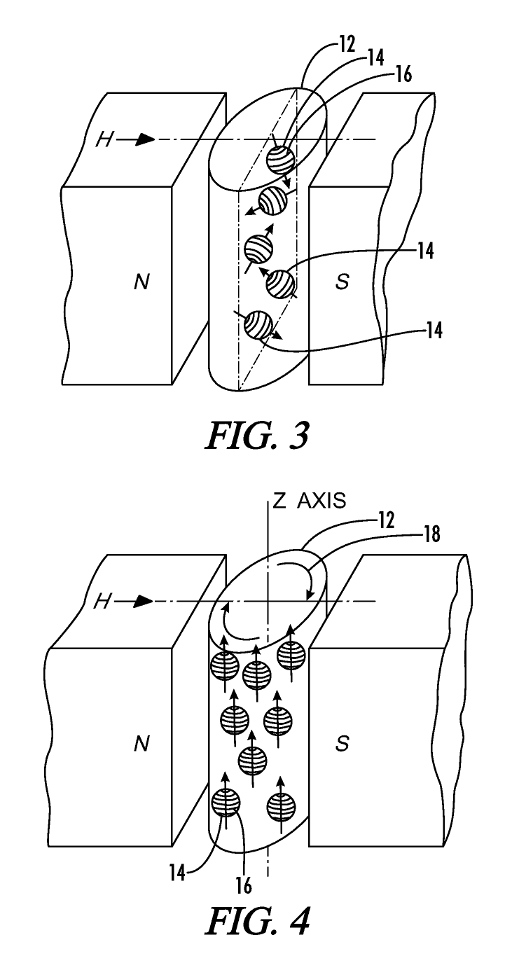

As will be described in detail below, in a first embodiment illustrated in FIGS. 3-7, preferably any one or any combination of steps (b), (c) and (e) may be performed while providing relative rotation between the material and a magnetic field so as to optimize the degree of orientation of the material as it transitions through its various phases through the process. Alternatively, step (d) may optional be performed at any time during the processes disclosed herein.

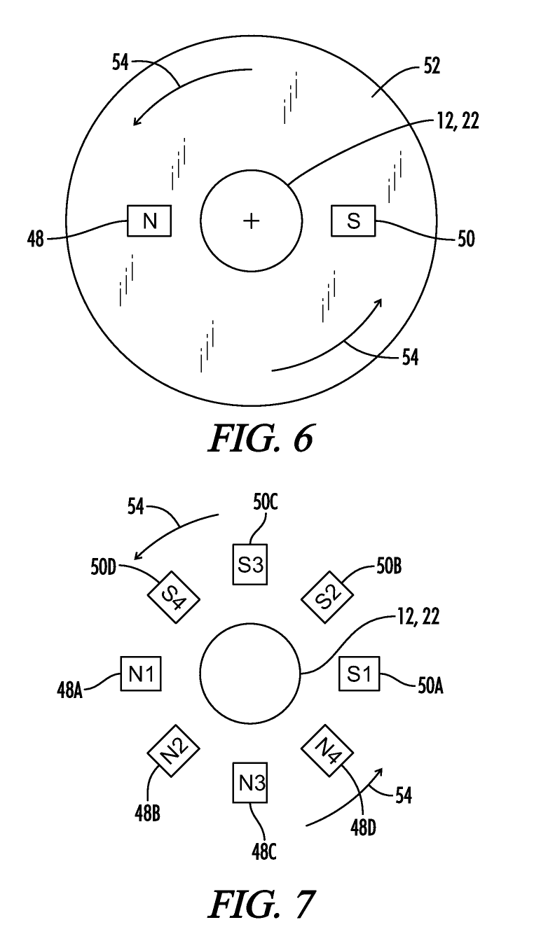

Alignment of the article in accordance with an embodiment of the disclosure may be effected by rotating the article , optionally in its molten state, about an axis perpendicular to the direction of a surrounding magnetic field (see FIGS. 3-5) or, alternatively, rotating the magnetic field itself about such axis (see FIGS. 6-7). The strength of the magnetic field and the rate of rotation of the body, or the field, may be such as will subject the pitch to a diamagnetic force which tends to align the layer planes of the mesophase portions of the pitch in a direction parallel to that of the magnetic field, and the c-axes of said layer planes parallel to the axis of rotation. These parameters thus depend to a large extent upon a number of factors including the size of the mesophase spheres or domains, the viscosity of the isotropic phase of the pitch, and the temperature employed. In an embodiment, the pitch is rotated relative to the magnetic field at a rate of at least 1 rpm in a field of at least 1 kilogauss in order to effect the desired alignment. In a further embodiment, the pitch is rotated at a rate of from 2 rpm to 100 rpm in a magnetic field of at least 2 kilogauss. However, orientation is not limited by the strength of the magnetic field. Examples of other suitable strengths of the magnetic field include as low as about 1 gauss; in another embodiment at least about 500 gauss. Alternatively, the orienting may include physically manipulating at least one of the powder, the molded article, the partially stabilized article to impart an alignment for the mesophase material in the article or powder. Such manipulation is also applicable to orientation during carbonization.

Mesophase pitches can be produced in accordance with known techniques by heating a carbonaceous pitch in an inert atmosphere at a temperature above about 350° C. for a time sufficient to produce the desired quantity of mesophase. By an inert atmosphere is meant an atmosphere which does not react with the pitch under the heating conditions employed, such as nitrogen, argon, xenon, helium, and the like. The heating period required to produce the desired mesophase content varies with the particular pitch and temperature employed, with longer heating periods required at lower temperatures than at higher temperatures. At 350° C., the minimum temperature generally required to produce mesophase, at least one week of heating is usually necessary to produce a mesophase content of about 40 per cent. At temperatures of from about 400° C. to 450° C., conversion to mesophase proceeds more rapidly, and a mesophase content approaching or greater than about 50% can usually be produced at such temperatures within about 1-40 hours. Such temperatures are preferred for this reason. Temperatures above about 500° C. are undesirable, and heating at this temperature should not be employed for more than about 5 minutes to avoid conversion of the pitch to coke.

Aromatic base carbonaceous pitches having a carbon content of from about 92% by weight to about 96% by weight and a hydrogen content of from about 4% by weight to about 8% by weight are generally suitable for producing mesophase pitches. Elements other than carbon and hydrogen, such as oxygen, sulfur and nitrogen, are undesirable and should not be present in excess of about 4% by weight. The presence of more than such amount of extraneous elements may disrupt the formation of carbon crystallites and prevent the development of a graphitic-like structure when attempts are made to carbonize or graphitize the pitch. In addition, the presence of extraneous elements reduces the carbon content of the pitch and hence the ultimate yield of the carbonized or graphitized product. When such extraneous elements are present in amounts of from about 0.5% by weight to about 4% by weight, the pitches generally have a carbon content of from about 92-95% by weight, the balance being hydrogen.

Petroleum pitch, coal tar pitch, coal extracts, and certain synthetic pitches such as naphthalene or acenaphthylene pitch are preferred starting materials for producing mesophase pitches. Petroleum pitch, of course, is the residuum carbonaceous material obtained from the distillation of crude oils or the catalytic cracking of petroleum distillates. Coal tar pitch is similarly obtained by the distillation of coal. Both of these materials are commercially available natural pitches. Coal extracts can be obtained by the hydrogenation of coal as in direct coal liquefaction. Naphthalene pitch can be obtained by catalytic polymerization using Lewis acids. Acenaphthylene pitch, on the other hand, can be produced by the pyrolysis of polymers of acenaphthylene as described by Edstrom et al. in U.S. Pat. No. 3,574,653, the details of which are incorporated herein by reference.

FIG. 3 schematically illustrates a sample 12 of mesophase pitch having mesophase portions 14, each mesophase portion comprising layer planes 16 of aligned molecules. While the layer planes of all the spheres are aligned parallel to the direction of magnetic field H, the polar or c-axes of the spheres are randomly oriented relative to each other.

In FIG. 4, in which the sample 12 is being rotated within the magnetic field as indicated by the arrows 18, not only are the layer planes 16 of the spheres 14 aligned parallel to the direction of magnetic field H, but, in addition, the polar or c-axes of the planes 16 are all aligned parallel to the axis of rotation of the pitch sample 12. The alignment of the polar axes of the spheres 14 in a direction parallel to the axis of rotation is a result of the propensity of the spheres to maintain, without interruption by rotation of the pitch, the orientation in which their layer planes are parallel to the direction of the magnetic field.

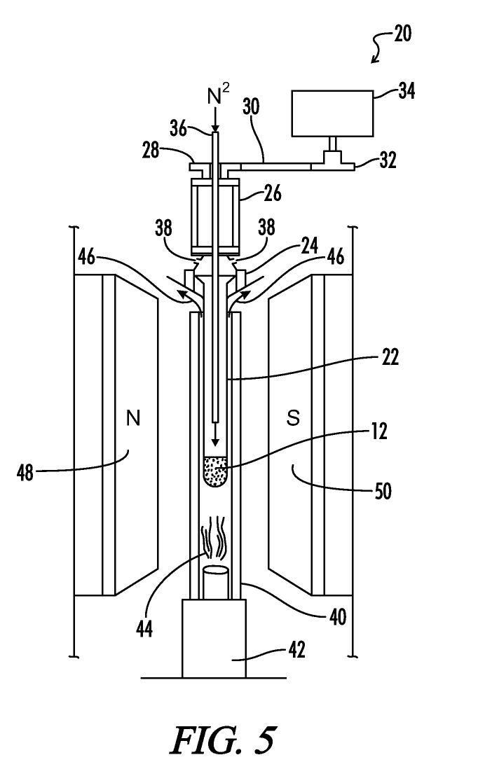

Referring now to FIG. 5, a schematic representation is shown of one apparatus 20 for rotating the sample 12 within the magnetic field as described above with regard to FIG. 4. In the apparatus 20, the sample 12 is contained in a rotating test tube 22. The test tube 22 is held by a rotating carrier 24 which is attached to a ball bearing shaft support 26. Attached to the shaft support 26 is a sprocket 28 which is driven by a chain 30 which is in turn driven by a second sprocket 32 driven by electric motor 34.

A nitrogen injection tube 36 extends downward through the rotating assembly into the test tube 22 to provide nitrogen or other inert gas into the test tube 22. The nitrogen is vented from the test tube 22 at vents 38. The test tube 22 rotates within an evacuated transfer tube 40. A heat source 42 which may, for example, be a Raytheon heat gun capable of providing temperature up to 550° C., is mounted in the lower end of the transfer tube 40. Heat from the heat source 42 flows upward to heat the test tube 22 and sample 12 within the transfer tube 40, as indicated at 44. Heat exits the upper end of transfer tube 40 in the small annulus between test tube 22 and transfer tube 40 as indicated by arrows 46.

The test tube 22 and sample 12 rotate within a magnetic field which exists between north and south poles 48 and 50 of a magnet assembly.

FIG. 6 schematically illustrates an alternative version of the apparatus 20 within which the north and south pole magnets 48 and 50 are mounted on a turntable 52 which rotates as indicated by arrows 54 relative to a stationary pitch sample 12 contained within stationary container 22.

FIG. 7 illustrates still another alternative embodiment in which the pitch sample 12 is located within a stationary container 22 in which a rotating magnetic field rotating in the direction of arrows 54 is created by electrically switching between a plurality of pairs of magnetic poles. By initially providing electric current to electromagnetic poles N1-S1 and then switching sequentially to N2-S2, then N3-S3, then N4-S4, then back to N1-S1 etc., a rotating magnetic field can be created without actually mechanically rotating any of the components.

As noted, stabilization of the powder is beneficial to enable production of monolithic graphite. It is believed that stabilization oxidizes the surface of the powder thereby cross-linking the atoms on the surface of the powder. In turn this inhibits coalescences, which allows volatiles to escape. Additionally, stabilization effected subsequent to the molding of the article, also has the advantage of cross-linking atoms of the surface of the article. Most preferably, stabilization is effected subsequent to alignment. In one embodiment, prior to stabilization, the pitch should advantageously be formed into particles having an average diameter so as to pass through a 20 U.S. mesh by, e.g., pulverization or other like process. More preferably, the mesophase pitch need not be smaller than so as to pass through a 400 U.S. mesh (about less than about 38 microns).

In a further embodiment, stabilization of the article may include at least partially thermosetting the mesophase pitch such that stabilized mesophase material will not remelt, thereby inhibiting disorientation. In another embodiment, substantially all, preferably all of the mesophase pitch in the article is stabilized so that it will not remelt. In another embodiment, stabilization may take place in the form of cross linking occurring at the pore walls within the article.

In one embodiment, to stabilize the article, whether prior to or subsequent to alignment, the article is exposed to a stabilization agent, which can be air or an oxidizing agent or a combination of both. Preferred oxidizing agents include nitric acid and a peroxide, especially hydrogen peroxide. The article is treated with the stabilization agent by either bubbling the stabilization agent through the article prior to alignment, or by other methods for ensuring intimate contact between the stabilization agent and the pitch particles. For additional disclosure regarding stabilization parameters, The North American Thermal Analysis Society (“NATAS”) Proceedings of Sep. 19-22, 1993, Denver, Colo. pages 183-187, author Richard T. Lewis.

In one certain embodiment, the article to be carbonized has sufficient porosity for a sufficient amount of any gases formed during carbonization and/or graphitization to escape the article such that no more than a non-significant amount of foaming would take place, if any.

The article is heated in a furnace to carbonize the article so as to give the article permanency of form and higher mechanical strength. Depending upon the size of the desired graphite body and upon the specific manufacturer's process, this “baking” step requires the article to be heat treated at a temperature of between about 700° C. and about 1100° C. To inhibit oxidation during bake, the article may be baked in the relative absence of air. The temperature of the article is raised at a constant rate to the final baking temperature. In some embodiments, the article is maintained at the final baking temperature for between 1 week and 2 weeks, depending upon the size of the article. Carbonization may be done after orienting or while in the magnetic field.

After baking, the article, referred to at this stage as carbonized body, is then graphitized. Graphitization is by heat treatment at a final temperature of between about 1500° C. to about 3400° C. for a time sufficient to cause the carbon atoms in the oriented, stabilized mesophase pitch to transform state into the crystalline structure of graphite. At these high temperatures, elements other than carbon are volatilized and escape as vapors.

After cooling and cleaning, the baked body may be impregnated one or more times with pitch, , suitable types of pitch may include mesophase pitch or conventional coal tar or petroleum pitch, or other types of pitches known in the industry, to deposit additional pitch coke in any open pores of the body. Each impregnation is then followed by an additional baking step, including cooling and cleaning. The time and temperature for each re-baking step may vary, depending upon the particular manufacturer's process. Re-baking can be conducted in a rotary magnetic field so as to orient the mesophase pitch in the impregnate in the same plane as in the mesophase was oriented in the green body. Additives may be incorporated into the pitch to improve specific properties of the graphite body. Each such densification step (i.e. each additional impregnation and re-baking cycle) generally increases the density of the stock material and provides for a higher mechanical strength. Typically, forming each body includes at least one densification step. Many such articles require several separate densification steps before the desired density is achieved.

After densification, the body, referred to at this stage as carbonized body, is then graphitized as discussed above.

After graphitization is completed, the body can be cut to size and then machined or otherwise formed into its final configuration. Given its nature, graphite permits machining to a high degree of tolerance, thus permitting a strong connection between graphite plates or the like.

In one embodiment the alignment of the layer planes of the mesophase portions of the mesophase pitch with each other to create an oriented mesophase pitch is preferably performed in accordance with the Singer process of U.S. Pat. No. 3,991,170. Furthermore, the enhanced alignment can be optimized by also conducting the carbonizing step while continuing to rotate the oriented pitch in a magnetic field in a manner similar to the Singer process.

One process which may be practiced to manufacturing a graphite body includes molding milled particles of mesophase pitch into a desired shaped article; orienting the article; and stabilizing the article. The process may also include carbonizing the article during at least a portion of the orienting. The orienting may include magnetically orienting the article. Orienting may further comprise providing relative rotation between the article and a magnetic field. In a certain embodiment, it is preferred that the mesophase pitch is oriented prior to a final stabilization.

A second process for manufacturing the afore graphite body may include molding milled particles of mesophase pitch into a desired shaped article; partially stabilizing the article; orienting the article; and stabilizing the oriented article. The process may also include carbonizing the article during at least a portion of the orienting. The orienting may comprise magnetically orienting the article. Such orienting may include providing relative rotation between the article and a magnetic field.

Another embodiment is a process for manufacturing a graphite body. The process may include partially stabilizing mesophase pitch molding powder; molding the powder into an article; orienting the article; and stabilizing the oriented article. The process may further include carbonizing the article and optionally subsequently graphitizing the article. Optionally the orienting of the article may occur while carbonizing the article. In a further embodiment, the orienting may include magnetically orienting the article. Furthermore, the process may include providing relative rotation between the article and a magnetic field.

Another embodiment disclosed herein may include casting mesophase pitch into a template. The template may be constructed from a sacrificial material in an approximate shape of the negative image of a desired graphite body, thereby forming a work piece. The work piece may be subjected to an orientation step. Additionally, the work piece may be subjected to a stabilization step. The mesophase pitch in the work piece may be carbonized. Also, the sacrificial material may be removed. Optionally, the carbonizing may occur prior to or subsequent to the removing of the sacrificial material.

A further embodiment described herein includes (a) impregnating a first body with mesophase pitch, thereby forming an impregnated body, the first body may include at least one material selected from carbon, graphite, and combinations thereof; (b) orienting the pitch in the impregnated body; and (c) carbonizing the pitch in the impregnated body, thereby forming a densified body. The process may also include stabilizing the impregnated body. In one certain embodiment, the orienting starts before the stabilizing.

In a particular embodiment, an advantage of partially stabilizing the particles which make up the molding powder prior to orientation is that the particles will exhibit less of a tendency to agglomerate. A further advantage of partial stabilization may be that, if desired, the partially stabilized particle will develop a skin around the exterior of the particle.

In another certain embodiment, the partial stabilization of particles in contact will develop a skin around that portion of the exterior not in contact with another particle. In such particles, a subsequent orientation will orient an across the boundary of one particle to the next for that portion of adjacent particles that are in contact.

In a further embodiment, orienting and stabilizing the article prior to carbonization enhances the ability to increase the conductivity of the article without further orienting the article during carbonization.

By the practice of the disclosed embodiments, a graphite article can be prepared using oriented mesophase pitch, to thus provide a graphite article having improved thermal conductivity and improved efficacy for use in applications such as electronic thermal management, lithium ion batteries or electrochemical fuel cells.

It is understood that the article upon processing such as carbonization and/or graphitization may under go a reduction (shrinkage) in size associated with the heating and cooling of the afore processes.

The various embodiments described above may be practiced in any and all combinations thereof. Furthermore, all patents referred to above are incorporated herein by reference in their entirety.

Thus it is seen that the apparatus and methods of the present invention readily achieve the ends and advantages mentioned as well as those inherent therein. While certain preferred embodiments of the invention have been illustrated and described for the purposes of the present disclosure, numerous changes in the construction and arrangement of parts and steps may be made by those skilled in the art, which changes are encompassed within the scope and spirit of the present claims.

What is claimed is:

1. A process for manufacturing a graphite body comprising:
a. molding milled particles of mesophase pitch into a desired shaped article;
b. orienting the article; and
c. stabilizing the article.

2. The process of claim 1 further comprising carbonizing the article during at least a portion of said orienting.

3. The process of claim 1 wherein the orienting comprises magnetically orienting the article.

4. The process of claim 3 further comprising providing relative rotation between the article and a magnetic field.

5. The process of claim 1 wherein a size of the particles comprises no more than 20 mesh on an average.

6. A process for manufacturing a graphite body comprising:
a. molding milled particles of mesophase pitch into a desired shaped article;
b. partially stabilizing the article;
c. orienting the article; and
d. stablizing the oriented article.

7. The process of claim 6 further comprising carbonizing the article during at least a portion of said orienting.

8. The process of claim 6 wherein the orienting comprises magnetically orienting the article.

9. The process of claim 8 further comprising providing relative rotation between the article and a magnetic field.

10. A process for manufacturing a graphite body comprising:
a. partially stabilizing mesophase pitch molding powder;
b. molding the powder into an article
c. orienting the article; and
d. stablizing the oriented article.

11. The process of claim 10 further comprising carbonizing the article.

12. The process of claim 11 further comprising orienting the article during said carbonizing.

13. The method of claim 10 wherein said orienting comprises magnetically orienting the article.

14. The process of claim 13 further comprising providing relative rotation between the article and a magnetic field.

15. A method of making a graphite body comprising
a. casting mesophase pitch into a template, the template constructed from a sacrificial material in an approximate shape of the negative image of a desired graphite article, thereby forming a work piece.
b. orienting the work piece;
c. stabilizing the work piece;
d. carbonizing at least the stabilized and oriented mesophase pitch; and
e. removing the sacrificial material.

16. The method of claim 15 wherein said carbonizing occurs prior to said removing.

17. The method of claim 15 wherein said removing occurs prior to said carbonizing.

18. A process of manufacturing a graphite body comprising:
a. impregnating a first body with mesophase pitch, thereby forming an impregnated body, the first body including at least one material selected from carbon, graphite, and combinations thereof;
b. orienting the pitch in the impregnated body; and
c. carbonizing the pitch in the impregnated body, thereby forming a densified body.

19. The process of claim 18 further comprising stabilizing the impregnated body.

20. The process of claim 19 wherein said orienting starts before said stabilizing.
